(19) United States
(12) Patent Application Publication
(10) Pub. No.: US 2021/0371208 A1
(43) Pub. Date: Dec. 2, 2021

(54) SCRAPPER SUITABLE FOR USE WITH A CONVEYING SYSTEM

(71) Applicant: SINGNERGY CORPORATION PTE. LTD., Singapore (SG)

(72) Inventor: Keng Tai CHUA, Singapore (SG)

(73) Assignee: SINGNERGY CORPORATION PTE. LTD., Singapore (SG)

(21) Appl. No.: 17/285,237

(22) PCT Filed: Oct. 11, 2019
(86) PCT No.: PCT/SG2019/050508

§ 371 Date: Apr. 14, 2021

(30) Foreign Application Priority Data
Oct. 23, 2018 (SG) 10201809366U

(51) Int. Cl. B65G 45/16

(52) U.S. Cl. CPC B65G 45/16

(57) ABSTRACT

There is provided a scrapper which can be suitable for use with a conveying system. The conveying system can include a conveying portion and a coupling part which can include a coupler. A coupler can be associated with a profile which can define the contour of the coupler. The scrapper can include a body portion which can include a coupling face and a scrapping face. The scrapping face can include one or more traveling portions and one or more contact portions. Matter carried by the conveying portion can be removed via the contact portion(s). When initial contact is established between the scrapper and a coupler, the travelling portion can make contact with the coupler in a manner so as to allow the scrapper to travel along the contour of the coupler.

### FIELD OF INVENTION

The present disclosure generally relates to a scrapper which can be suitable for scrapping of matter carried by the conveyor part of a conveying system.

### BACKGROUND

In a typical conveyor system, it is not uncommon for jamming to be encountered.

Specifically, in a typical conveyor system, conveyor belts are used to transport matter. Such conveyor belts typically remain in continuous movement during operation.

However, conveyor belts can be unintentionally caused to stop (i.e., forced stop) due to mechanical obstruction. Such forced stops can be referred to as “jamming”.

Appreciably, when jamming occurs, the operation of a conveyor system could be adversely impacted.

The present disclosure contemplates that there is a need for a solution to address, at least in part, the issue of jamming.

### SUMMARY OF THE INVENTION

In accordance with an aspect of the disclosure, there is provided a scrapper which can be suitable for use with a conveying system.

The conveying system can include a conveying portion capable of carrying matter and conveying carried matter from one point (e.g., one location in a building) to another point (e.g., another location in a building).

The conveying portion can include a conveyor part (e.g., in the form of a conveyor belt) which can be based on a plurality of sections (i.e., in the form of a plurality of conveyor belt sections). The conveying portion can further include a coupling part. The coupling part can include one or more couplers.

One section of the conveyor part can be coupled to another section of the conveyor part by at least one coupler. A coupler can be associated with a profile which can define the contour of the coupler.

The scrapper can include a body portion which can include a coupling face and a scrapping face. The coupling face and the scrapping face can be opposing faces of the body portion.

The scrapping face can include one or more traveling portions and one or more contact portions.

The coupling face can be coupled to a support structure so that the scrapper can be capable of being supported in a manner so as to be positioned relative to the conveying portion such that matter carried by the conveyor part is capable of being removed via the contact portion(s). In one example, the coupling face can be coupled to the support structure by manner of resilient based coupling.

When initial contact is established between the scrapper and a coupler, the travelling portion(s) can make contact with a coupler in a manner so as to allow the scrapper to travel along the contour of the coupler. In this regard, the travelling portion(s) can facilitate travelling of the scrapper along the contour of a coupler.

In one embodiment, a travelling portion can be shaped and dimensioned so as to define a curvilinear based profile. In one example, a travelling portion can correspond to a curved portion.

In one embodiment, a contact portion can be shaped and dimensioned so as to define an edged slopping based profile.

In one example, a contact portion can correspond to a scrapping structure which can be associated with an edged slopping profile. The scrapping structure can effectively act as a shovel capable of shovelling carried matter off the conveyor part.

### BRIEF DESCRIPTION OF THE DRAWINGS

Embodiments of the disclosure are described hereinafter with reference to the following drawings, in which:

FIG. 1a and FIG. 1b show a system which can, for example, correspond to a conveying system which can include one or more scrappers, according to an embodiment of the disclosure;

FIG. 2a and FIG. 2b show a scrapper of FIG. 1 in further detail, according to an embodiment of the disclosure;

FIG. 3 shows an exemplary scenario in association with the system of FIG. 1, according to an embodiment of the disclosure; and

FIG. 4 shows an exemplary implementation in association with the system of FIG. 1, according to an embodiment of the disclosure.

### DETAILED DESCRIPTION

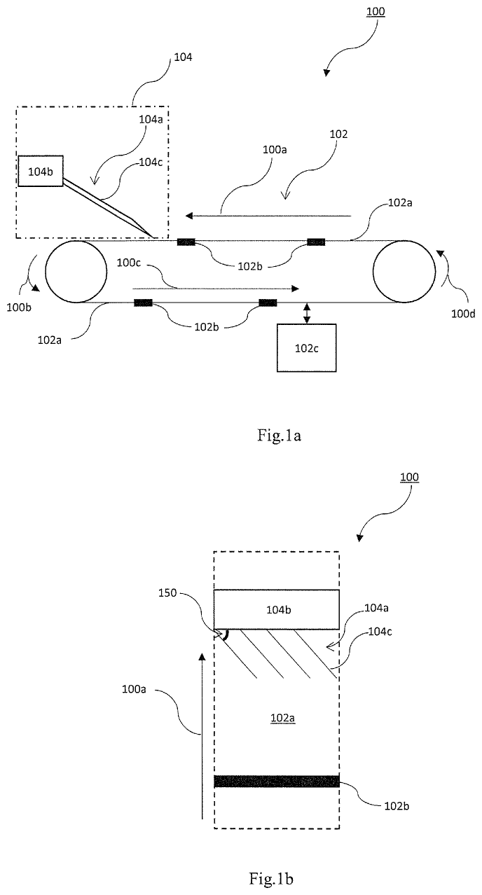

Referring to FIG. 1, there is shown a system 100, according to an embodiment of the disclosure. The system 100 can, for example, correspond to a conveying system.

Specifically, FIG. 1 a shows a first view, looking from one side (e.g., left/right side), of the system 100, according to an embodiment of the disclosure and FIG. 1b shows a second view of the system 100 according to an embodiment of the disclosure. The second view can, for example, correspond to a plane view (e.g., looking from the top) of the system 100, according to an embodiment of the disclosure.

The system 100 can include a conveying portion 102 and a scrapping portion 104. The conveying portion 102 can be operated in a manner so as to carry matter and conveying carried matter. The scrapping portion 104 can be positioned relative to the conveying portion 102.

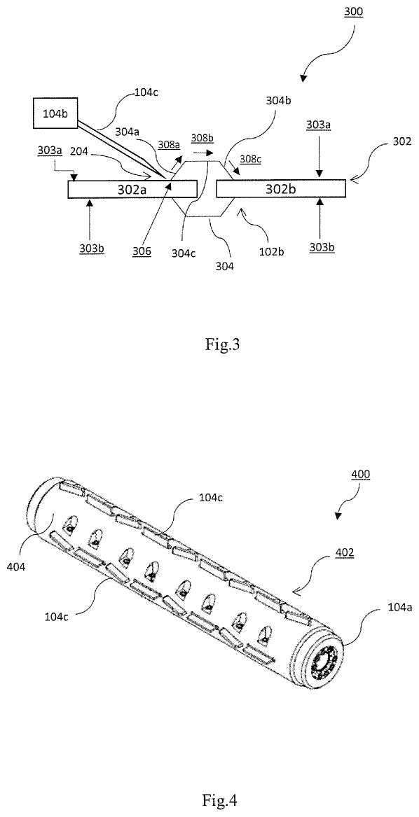

The conveying portion 102 can be associated with/correspond to a conveyor assembly. The conveying portion 102 can, for example, include a conveyor part 102a, a coupling part 102b and a moving part 102c. The conveying portion 102 can further include a conveyor support structure (not shown). The coupling part 102b can include one or more couplers as will be discussed later in further detail with reference to FIG. 3, according to an embodiment of the disclosure.

The conveyor part 102a can be based on a plurality of sections and one section of the conveyor part 102a can be coupled to another section of the conveyor part 102a by one or more couplers from the coupling part 102b. Moreover, the conveyor part 102a can be coupled to the moving part 102c.

In one embodiment, the conveyor part 102a can be in the form of a conveyor belt which can, for example, correspond to an endless type belt. A conveyor belt can include a plurality of belt sections. One belt section can be coupled to another belt section by a coupler from the coupling part 102b. Moreover, the conveyor part 102a can be shaped and dimensioned in a manner so as to be capable of carrying matter (e.g., sludge, dried goods, livestock feed).

As mentioned, a coupler from the coupling part 102b can couple one section of the conveyor part 102a to another section of the conveyor part 102a.

In one embodiment, a coupler (i.e., from the coupling part 102b) can be shaped and dimensioned in a manner so as to be capable of holding one section of the conveyor part 102a and another section of the conveyor part 102a together. A coupler (i.e., from the coupling part 102b) can be associated with a profile. In one example, a coupler can be in the form of a protruding section with a slopping profile (e.g., slopping faces). A coupler can be considered to be protruding relative to the conveyor part 102a. For example, a coupler can be visually perceived to be extending from the conveyor part 102a. The coupling part 102b will be discussed in further detail with reference with FIG. 3 later.

In one embodiment, the conveyor support structure (not shown) can, for example, be in the form of a frame which can, for example, correspond to a roller type frame.

The conveyor support structure can be shaped and dimensioned in a manner so as to support the conveyor part 102a.

In one embodiment, the moving part 102c can, for example, be in the form of a moving system (e.g., an assembly which can include actuator(s), roller(s), gear(s) and/or motor(s)) suitable for causing the conveying part 102a to move in a manner so that matter carried by the conveying part 102a can be moved/transported from one point to another point. For example, the conveying part 102a can be moved in a manner as depicted by directional arrows 100a, 100b, 100c and 100d.

As mentioned earlier, the scrapping portion 104 can be positioned relative to the conveying portion 102. Specifically, the scrapping portion 104 can be positioned in a manner so as to be capable of removing matter carried by the conveying portion 102. More specifically, the scrapping portion 104 can be positioned relative to the conveying portion 102 in a manner so as to be capable of removing matter (i.e., from the conveying portion 102) carried by the conveyor part 102a.

The scrapping portion 104 can, for example, include a scrapper part 104a and a scrapper support structure 104b. The scrapper part 104a can be coupled to the scrapper support structure 104b.

The scrapper part 104a can one or both of include and carry one or more scrappers 104c. In one embodiment, the scrapper part 104a can correspond to a carrying structure (i.e., as will be discussed later in the context of an exemplary implementation with reference to FIG. 4). In another embodiment, the scrapper part 104a can correspond to one or more scrappers 104c. In yet another embodiment, the scrapper part 104a can correspond to both a carrying structure and one or more scrappers 104c.

The scrapper(s) 104c can be profiled in a manner such that the scrapper(s) 104c can travel along the profile associated with a coupler (i.e., from the coupling part 102b) when the scrapper(s) 104c come into contact with the coupler.

As mentioned, the scrapper part 104a can be coupled to the scrapper support structure 104b. Specifically, the scrapper support structure 104b can be configured in a manner so as to one or both of support and carry the scrapper part 104a such that the scrapper(s) 104c can be appropriately positioned relative to the conveying portion 102.

More specifically, as shown in FIG. 1b, the scrapper part 104a can be supported and/or carried such that the scrapper(s) 104c can be in slanted position relative to a coupler (i.e., from the coupling part 102b). Yet more specifically, the scrapper part 104a can be supported and/or carried such that the scrapper(s) 104c can be in slanted position facing a coupler (i.e., from the coupling part 102b).

In one example, according to an embodiment of the disclosure (e.g., where the scrapper part 104a corresponds to one or more scrappers 104c), the scrapper(s) 104c can be directly coupled to the scrapper support structure 104b based on a coupling angle 150. The coupling angle 150 can, for example, range from an angle of 5 degrees to an angle of 60 degrees. In this regard, when the scrapper(s) 104c face a coupler, the scrapper(s) 104c can be in slanted position relative to the coupler.

In another example, according to an embodiment of the disclosure (e.g., where the scrapper part 104a corresponds to a carrying structure carrying one or more scrappers 104c), the scrapper(s) 104c can be indirectly coupled (i.e., via the carrying structure) to the scrapper support structure 104b such that the scrapper(s) 104c can be in slanted position based on the aforementioned coupling angle 150. The coupling angle 150 can, for example, range from an angle of 5 degrees to an angle of 60 degrees. The coupling angle 150 can be in respect of one of both of:
1. coupling between the scrapper(s) 104c and the carrying structure
2. coupling between the carrying structure and the scrapper support structure 104b

In one embodiment, the scrapper support structure 104b can be arranged to hold the scrapper part 104a relative to the conveying portion 102 such that the scrapper(s) 104c can be in inclined position (e.g., slopping position) relative to the conveyor part 102a.

In another embodiment, the scrapper support structure 104b can be arranged to hold the scrapper part 104a relative to the conveying portion 102 such that the scrapper(s) 104c can be in substantially perpendicular position (e.g., upright position) relative to the conveyor part 102a.

In yet another embodiment, a scrapper 104c can be held (i.e., by the scrapper support structure 104b) in an inclined position relative to the conveyor part 102a whereas another scrapper 104c can be held (i.e., by the scrapper support structure 104b) in a substantially perpendicular position relative to the conveyor part 102a.

In this regard, it is appreciable that the scrapper part 104a can be coupled to the scrapper support structure 104b in a manner such that the scrapper(s) 104c can be positionally held in one or both of inclined manner relative to the conveyor part 102a and upright manner relative to the conveyor part 102a.

Moreover, the scrapper part 104a can be coupled to the scrapper support structure 104b in a manner such that the scrapper(s) 104c can be resiliently coupled to the scrapper support structure 104b, according to an embodiment of the disclosure. Resilient coupling can, for example, be by manner of a spring-based arrangement.

Additionally, the scrapper part 104a can be coupled to the scrapper support structure 104b in a manner such that the scrapper(s) 104c can be coupled to the scrapper support structure 104b in hinged manner/pivotable manner, according to an embodiment of the disclosure. Hinged coupling can, for example, be analogous to door hinge type coupling.

Furthermore, the scrapper part 104a can be coupled to the scrapper support structure 104b in a manner such that the scrapper(s) 104c can be rigidly coupled to the scrapper support structure 104b, according to an embodiment of the disclosure.

Yet further more, the scrapper part 104a can be coupled to the scrapper support structure 104b in a manner such that the one or more scrappers 104c can be resiliently coupled to the scrapper support structure 104b, another one or more scrappers 104c can be rigidly coupled to the scrapper support structure 104b and yet another one or more scrappers 104c can be coupled to the scrapper support structure 104b in a hinged manner, according to an embodiment of the disclosure

In this regard, the scrapper part 104a can be coupled to the scrapper support structure 104b in a manner such that the scrapper(s) 104c can be coupled to the scrapper support structure 104b in a resilient manner, a rigid manner, a hinged manner, or any combination thereof. Specifically, the scrapper(s) 104c can be coupled to the scrapper support structure 104b in a resilient manner, a rigid manner and/or a hinged manner.

Moreover, the scrapper(s) 104c can be held (i.e., by the scrapper support structure 104b) in one or both of contact based manner and contactless manner relative to the conveyor part 102a. The scrapper(s) 104c can be held in manner so as to one or both of come into contact with the conveyor part 102a and be contact-free from the conveyor part 102a. For example, a scrapper 104c can be held in a manner so as to come into contact with the conveyor part 102a whereas another scrapper 104c can be held in a manner so as to remain contact-free from the conveyor part 102a.

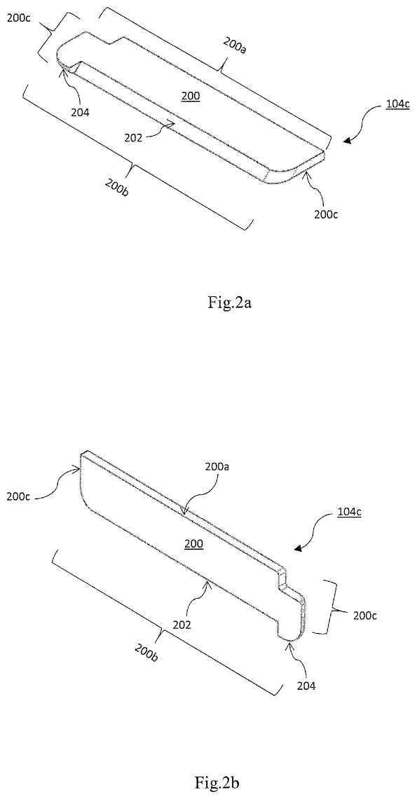

The scrapper(s) 104c will be discussed later in further detail with reference to FIG. 2.

In an exemplary operation, the conveyor part 102a can carry one or more items (sludge, dried goods, livestock feed etc.) and can be caused to move (i.e., caused to move, as depicted by directional arrows 100a/100b/100c/100d, by the moving part 102c) so that the item(s) carried thereon can be conveyed from one point (e.g., a location in a building such as a warehouse) to another point (e.g., another location in the building). The scrapper part 104a can be supported in a manner such that the scrapper(s) 104c can be appropriately positioned relative to the conveying portion 102 so as to remove carried matter from the conveyor part 102a. Appreciably, the conveyor part 102a can be in constant motion (i.e., as depicted by directional arrows 100a/100b/100c/100d) relative to the scrapper part 104a. The scrapper part 104a can, in one embodiment, be considered to be fixed in position relative to the conveyor part 102a. The conveyor part 102a can be associated with a width and a length. The width can determine the extent of width associated with the item placed on the conveyor part 102a. Additionally, the conveyor part 102a can be moved by the moving part 102c such that the conveyor part 102a can be considered to be running along its length (i.e., as depicted by directional arrow 100a) when caused to move (i.e., in a direction as depicted by directional arrow 100a).

For example, the scrapper part 104a can carry/include a plurality of scrappers 104c. The scrappers 104c can be spaced apart along and arranged in line across the width of the conveyor part 102a. Moreover, the scrappers 104c can be can be resiliently coupled (e.g., by manner of a spring-based arrangement) to the scrapper support structure 104b. Furthermore, the scrapper support structure 104b can be arranged to hold the scrapper part 104a relative to the conveying portion 102 such that the scrapper(s) 104c can be in inclined position (e.g., slopping position) relative to the conveyor part 102a. Yet furthermore, the scrappers 104c can be held (i.e., by the scrapper support structure 104b) by contact based manner such that the scrappers 104c can be urged (e.g., pressed) against the conveyor part 102a.

In the exemplary operation, an item can initially be placed (i.e., an originating position) on the conveyor part 102a. The item can subsequently be moved/transported (i.e., by virtue of the moving conveyor part 102a) toward (i.e., as depicted by directional arrow 100a) the scrapper part 104a. When the item comes into contact with the scrapper(s) 104c, the scrapper(s) 104c can cause the item to be removed from the conveyor part 102a.

Earlier mentioned, a coupler (i.e., from the coupling part 102b) can be considered to be protruding relative to the conveyor part 102a. In this regard, it is appreciable that the scrapper(s) 104c can also come into contact with the coupler(s).

The present disclosure contemplates that the scrapper(s) 104c can be shaped and configured in a manner so as to be capable of traveling along the profile(s) associated with the coupler(s) (i.e., from the coupling part 102b) when the scrapper(s) 104c come into contact with the coupler(s). In this manner, the issue of jamming can at least be substantially addressed. Specifically, the occurrence of the conveyor part 102a being jammed due to contact between the scrapper(s) 104c and the coupler(s) (e.g., mechanical obstruction) can be substantially reduced since the scrapper(s) 104c can travel along the profile(s) associated with the coupler(s) (i.e., from the coupling part 102b) when the scrapper(s) 104c can come into contact with the coupler(s).

Furthermore, since the scrappers 104c can, for example, be resiliently coupled (e.g., by manner of a spring-based arrangement) to the scrapper support structure 104b and, for example, urged (e.g., pressed) against the conveyor part 102a, it is appreciable that after the scrappers 104c travel along the profile of a coupler (i.e., at which point, contact between the scrappers 104c and the conveyer part 102a would be considered to be broken), the scrappers 104c can return to being urged (e.g., pressed) against the conveyer part 102a.

Referring to FIG. 2a and FIG. 2b, the aforementioned scrapper 104c is shown in further detail, according to an embodiment of the disclosure.

Specifically, FIG. 2a shows a perspective of the aforementioned scrapper 104c, according to an embodiment of the disclosure. FIG. 2b shows another perspective of the aforementioned scrapper 104c, according to an embodiment of the disclosure.

As shown, a scrapper 104c can include a body portion 200. The body portion 200 can include a coupling face 200a and a scrapping face 200b. The coupling face 200a and the scrapping face 200b can be opposing faces of the body portion 200.

Specifically, the coupling face 200a can be opposite to the scrapping face 200b. Moreover, the coupling face 200a and the scrapping face 200b can be spaced apart such that the sides 200c can be defined between the coupling and scrapping faces 200a/200b.

In accordance with an embodiment of the disclosure, the coupling face 200a can face the scrapper support structure 104b and the scrapping face 200b can face the conveying portion 102.

Specifically, the coupling face 200a can be coupled to the scrapper support structure 104b and the scrapping face 200b can either be adjacent to or be in-contact with the conveying portion 102, according to be embodiment of the disclosure.

Appreciably initial contact between a scrapper 104c and an item and/or a coupler (i.e., from the coupling part 102b) can be at the scrapping face 200b.

The scrapping face 200b can include at least one contact portion 202 and at least one travelling portion 204. Specifically, the scrapping face 200b can be shaped and dimensioned in a manner so as to define at least one contact portion 202 and at least one travelling portion 204. The contact portion(s) 202 can be coupled to the travelling portion(s) 204.

In one example, the scrapping face 200b can include one contact portion 202 and one travelling portion 204. The travelling portion 204 can be coupled to one end of the contact portion 202. Specifically, the travelling portion 204 can be coupled to the contact portion 202 at one extremity of the contact portion 202.

In another example, the scrapping face 200b can include one contact portion 202 and a plurality of travelling portions 204 (e.g., two travelling portions 204). The contact portion 202 can, for example, include two ends and one travelling portion 204 can be coupled to each end of the contact portion 202. Specifically, one travelling portion 204 can be coupled to each extremity of the contact portion 202.

In yet another example, the scrapping face 200b can include a plurality of contact portions 202 (e.g., two contact portions 202) and one or more travelling portions 204. At least one travelling portion 204 can be disposed between two contact portions 202. Specifically, at least one travelling portion 204 can couple two contact portions 202. In this regard, one end of each of the two contact portions 202 can be considered to be coupled to at least one travelling portion 204. Moreover, one or both of another end of each of the two contact portions 202 can, for example, be coupled to a travelling portion 204.

In one embodiment, a contact portion 202 can be shaped and dimensioned such that an edged slopping based profile can be defined. In this regard, a contact portion 202 can correspond to, for example, a scrapping structure which can be associated with an edged slopping profile (e.g., in the form of a blade). In operation (e.g., the earlier mentioned exemplary operation), a contact portion 202 can contact an item (i.e., carried by the conveyor part 102a) in a manner so as to remove the item from the conveyor part 102a. Contact between the contact portion 202 can, for example, be such that an item (i.e., due to the moving conveyor part 102a carrying the item) is pushed against the contact portion 202 (e.g., in a direction as depicted by directional arrow 100a) and the edged slopping based profile can effectively act as a shovel which can shovel the item off the conveyor part 102a.

In one embodiment, a travelling portion 204 can be shaped and dimensioned such that a curvilinear based profile can be defined. For example, the travelling portion 204 can correspond to a curved portion. In operation, the travelling portion 204 can contact a coupler (i.e., from the coupling part 102b) in a manner so as to allow the scrapper 104c to travel along the profile associated with the coupler. In this manner, when a scrapper 104c is caused to be pushed against a coupler (i.e., due to the moving conveyor part 102a), avoidance of the jamming of the conveyor part 102a (i.e., bearing in mind that the conveyor part 102a will continue to be caused to move by the moving part 102c despite contact between the scrapper(s) 104c and the coupler(s)) can be facilitated.

Specifically, the conveyor part 102a can still be allowed to move contact despite between the scrapper(s) 104c and a coupler (i.e., from the coupling part 102b) since the travelling portion(s) 204 can facilitate the travelling of the scrapper(s) 104c along the profile associated with the coupler(s). More specifically, movement of the conveyor part 102a can continue/remain unimpeded despite contact between the scrapper(s) 104c and the coupler(s) (i.e., from the coupling part 102b) since the travelling portion(s) 204 can facilitate the travelling of the scrapper(s) 104c along the profile associated with the coupler(s) such that the scrapper(s) 104c can, effectively, travel over the coupler(s) (i.e., from the coupling part 102b) when the scrapper(s) 104c and a coupler come into initial contact. This will be discussed in further detail with reference to FIG. 3 hereinafter.

Referring to FIG. 3, an exemplary scenario 300 in association with the system 100 is shown, according to an embodiment of the disclosure.

As shown, in the exemplary scenario 300, the conveyor part 102a can include a plurality of conveyor sections 302. For example, the conveyor part 102a can include a first conveyor section 302a and a second conveyor section 302b.

Each conveyor section can include a carrying face 303a and a non-carrying face 303b. The carrying face 303a and the non-carrying face 303b can be opposing faces of a conveyor section. Matter (e.g., an item) can be carried by a conveyor section on the carrying face 303a.

The first conveyor section 302a and the second conveyor section 302a can be coupled together by at least one coupler 304 from the coupling part 102b.

Further shown, a coupler 304 (i.e., from the coupling part 102b) can be associated with a profile which can include a first slopping face 304a, a second slopping face 304b and a non-slopping face 304c. The first and second slopping faces 304a/304b can be spaced apart such that the non-slopping face 304c can be defined between the first and second slopping faces 304a/304b. Moreover, the first and second slopping faces 304a/304b can be considered to be opposing faces of the coupler 304.

The profile of a coupler 304 can, for example, correspond to the coupler 304 contour. The contour/profile of the coupler 304 can, for example, define the surface of the coupler 304.

In this regard, the contour/profile of a coupler 304 can be based on the first slopping face 304a, the second slopping face 304b and the non-slopping face 304c. Specifically, in one embodiment, the first slopping face 304a, the second slopping face 304b and the non-slopping face 304c can, in combination, define the surface/contour(s) of a coupler 304. More specifically, in one embodiment, the first slopping face 304a, the second slopping face 304b and the non-slopping face 304c can, in combination, define the surface/contour(s) of a coupler 304 extending from at least a portion of the carrying face(s) 303a of the conveyor section(s) (e.g., extending from at least a portion of the carrying faces 303a of the first and second conveyor sections 302a/302b).

Initial contact between the scrapper 104c and a coupler 304 can be depicted by arrow 306. After initial contact, the scrapper 104c can travel along a coupler 304 (i.e., as depicted by directional arrows 308a, 308b and 308c) as the conveyor part 102a remains in motion such that the coupler 304 is urged against the scrapper 104c.

Earlier mentioned, the scrapper(s) 104c can be in slanted position facing a coupler.

The present disclosure contemplates that, in one embodiment, the scrapper(s) 104c can be in slanted position facing a coupler such that when the scrapper 104c comes into initial contact with a coupler 304, a travelling portion 204 (i.e., as opposed to the contact portion 202) can come into initial contact with the coupler 304.

For example, as the scrapper 104c comes into initial contact with a coupler 304, the travelling portion(s) 204 can first come into contact with the first slopping face 304a and facilitate travelling of the scrapper 104c up the first slopping face 304a. The scrapper 104c can continue to travel (i.e., by virtue of the scrapper 104c being urged against the coupler 304) along the first slopping face 304a from the carrying face of one conveyor section (i.e., from the carrying face 303a of the first conveyor section 302a) toward the non-slopping face 304c, followed by continual travelling along the non-slopping face 304c toward the second slopping face 304b and, subsequently along the second slopping face 304b toward the carrying face of another conveyor section (i.e., toward the carrying face 303a of the second conveyor section 302b).

In the above exemplary manner, the scrapper 104c can be considered to be capable of travelling along a coupler 304. Specifically, the scrapper 104c can be considered to be capable of travelling along the surface/contour(s) of a coupler 304 after initial contact is established between the scrapper 104c and the coupler 304.

In view of the foregoing, it is appreciable that the present disclosure contemplates a scrapper 104c which can be suitable for use with a conveying system 100.

The conveying system 100 can include a conveying portion 102 which can be capable of carrying matter (e.g., sludge, dried goods, livestock feed) and conveying carried matter from one point to another point (e.g., from one location in a building such as a warehouse to another location in the building).

The conveying portion 102 can include a conveyor part 102a and a coupling part 102b which can include at least one coupler 304. The conveyor part 102a can be based on a plurality of sections (e.g., a first conveyor section 302a and a second conveyor section 302b). The coupler 304 can couple one section of the conveyor part 102a (e.g., the first conveyor section 302a) to another section of the conveyor part 102a (e.g., the second conveyor section 302b).

The coupler 304 can be associated with a profile which defines the contour of the coupler 304. In one example, the contour of the coupler 304 can be based on a first slopping face 304a, a second slopping face 304b and a non-slopping face 304c.

The scrapper 104c can include a body portion 200. The body portion 200 can include a coupling face 200a and a scrapping face 200b. The coupling face 200a and the scrapping face 200b can be opposing faces of the body portion 200.

The scrapping face 200b can include at least one contact portion 202 and at least one traveling portion 204.

The coupling face 200a can be capable of being coupled to a support structure 104b so that the scrapper 104c can be capable of being supported in a manner so as to be positioned relative to the conveying portion 102 such that matter carried by the conveyor part 102a can be capable of being removed via the contact portion 202. In one example, the coupling face 200a can be capable of being coupled to the support structure 104b by manner of resilient based coupling (e.g., a spring-based arrangement).

Additionally, when initial contact is established between the scrapper 104c and the coupler 304, the travelling portion 204 can be capable of contacting the coupler 304 in a manner so as to allow the scrapper 104c to travel along the contour of the coupler 304.

In one embodiment, the travelling portion 204 can be shaped and dimensioned so as to define a curvilinear based profile. In one example, the travelling portion 204 can correspond to a curved portion.

In one embodiment, the contact portion 202 can be shaped and dimensioned so as to define an edged slopping based profile.

In one example, the contact portion 202 can correspond to a scrapping structure which can be associated with an edged slopping profile. The scrapping structure can be capable of effectively acting as a shovel capable of shovelling carried matter off the conveyor part 102a.

Referring to FIG. 4, an exemplary implementation 400 in association with the system 100 is shown, according to an embodiment of the disclosure.

Earlier mentioned, the scrapper part 104a can correspond to a carrying structure.

In regard to the exemplary implementation 400, the scrapper part 104a can correspond to a carrying structure which can be in the form of a roller 402. The roller 402 can be configured to carry one or more scrappers 104c. Appreciably, the roller 402 can be coupled to the scrapper support structure 104b in a rotatable manner. Moreover, the scrapper(s) 104c can be carried by the roller 402 in a slanted manner based in the aforementioned coupling angle 150.

Specifically, the roller 402 can include a curvilinear surface 404 (e.g., in the form of a cylindrical drum). One or more scrappers 104c can be carried by the curvilinear surface 404.

In one embodiment, the curvilinear surface 404 can carry at least one array of scrapper(s) 104c (i.e., one or more arrays of scrapper(s) 104c). For example, an array of scrapper(s) 104c can correspond to a plurality of scrappers 104c spaced apart in a line based arrangement/fashion (i.e., a line of spaced apart scrappers 104c).

In one embodiment, the curvilinear surface 404 can be further configured to carry one or more brushes. A brush can be used for cleaning, for example, debris off the conveyor part 102a (i.e., carrying face 303a of a conveyor section). In this regard, the curvilinear surface 404 can carry one or more arrays of brush(es) (e.g., in a line based arrangement), according to an embodiment of the disclosure. For example, the curvilinear surface 404 can carry arrays of brushes and arrays of scrappers 104c. In a more specific example, the arrays of brushes and the arrays of scrappers 104c can be carried by the curvilinear surface in an alternate based spaced apart arrangement/fashion (e.g., a row of scrappers 104c followed by a row of brushes which is followed by a row of scrappers 104c and so on).

In one embodiment, the curvilinear surface 404 can be configured to carry one or more arrays based on a combination of one or more scrappers 104c and one or more brushes. For example, an array can correspond to a row having scrappers 104c and brushes in an alternate based spaced apart arrangement/fashion (e.g., a scrapper 104c followed by a brush which is followed by a scrapper 104c and so on).

It should be further appreciated by the person skilled in the art that variations and combinations of features described above, not being alternatives or substitutes, may be combined to form yet further embodiments.

In one example, earlier mentioned, the contour of a coupler (i.e., from the coupling part 102b) can be based on a first slopping face 304a, a second slopping face 304b and a non-slopping face 304c.

The present disclosure further contemplates that the contour of a coupler (i.e., from the coupling part 102b) can be based on a first slopping face 304a, a second slopping face 304b, a non-slopping face 304c or any combination thereof.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1. A scrapper suitable for use with a conveying system which includes a conveying portion capable of carrying matter and conveying carried matter from one point to another point, the conveying portion includes a conveyor part based on a plurality of sections and a coupling part which includes at least one coupler wherein one section of the conveyor part is capable of being coupled to another section of the conveyor part by a coupler, a coupler being associable with a profile which defines the contour of the coupler, the scrapper comprising:
a body portion comprising:
a coupling face; and
a scrapping face comprising:
at least one traveling portion; and
at least one contact portion,
wherein the coupling face and the scrapping face are opposing faces of the body portion,
wherein the coupling face is capable of being coupled to a support structure so that the scrapper is capable of being supported in a manner so as to be positioned relative to the conveying portion such that matter carried by the conveyor part is capable of being removed via the contact portion, and
wherein when initial contact is established between the scrapper and a coupler, the travelling portion is capable of contacting the coupler in a manner so as to allow the scrapper to travel along the contour of the coupler.

2. The scrapper as in claim 1, wherein the travelling portion is shaped and dimensioned so as to define a curvilinear based profile.

3. The scrapper as in claim 2, wherein the travelling portion corresponds to a curved portion.

4. The scrapper as in claim 1, wherein the contact portion is shaped and dimensioned so as to define an edged slopping based profile.

5. The scrapper as in claim 1, wherein the contact portion corresponds to a scrapping structure associable with an edged slopping profile, the scrapping structure capable of effectively acting as a shovel capable of shovelling carried matter off the conveyor part.

6. The scrapper as in claim 1, the coupling face is capable of being coupled to the support structure by manner of resilient based coupling.
